(19) United States
(12) Patent Application Publication
(10) Pub. No.: US 2014/0379541 A1
(43) Pub. Date: Dec. 25, 2014

(54) SYSTEMS AND METHODS FOR REMOTE CLEARING OF PAYMENT CARD TRANSACTIONS

(71) Applicant: MasterCard International Incorporated, Purchase, NY (US)

(72) Inventor: Thomas M. Wolf, High Ridge, MO (US)

(21) Appl. No.: 13/926,264

(22) Filed: Jun. 25, 2013

(51) Int. Cl. G06Q 40/00

(52) U.S. Cl. CPC G06Q 40/00
USPC 705/35

(57) ABSTRACT

A method and system for clearing payment card transactions using a computer device coupled to a database are provided. The method includes receiving from one or more local clearing users, financial transaction data relating to purchases made at one or more merchants by a plurality of payment card cardholder, the local clearing users located within a single clearing region, checking the received financial transaction data for errors, and performing a batch clearing process within the single clearing region on financial transaction data received in a predetermined period from the local clearing users within the single clearing region.

### BACKGROUND OF THE INVENTION

This invention relates generally to processing payment card transactions and, more particularly, to computer systems and computer-based methods for processing payment card transactions remotely and separately from a central processing interchange.

Typically, payment card transactions are processed in a central location using a large scale processing platform, such as, but, not limited to a main frame application suite operating on a main frame computer system. Such platforms are highly efficient for processing a large plurality of transaction messages from a large plurality of clearing users. The application suite includes software components configured to apply local rules to the data processed and to preclude at least most data containing errors from affecting the clearance components' operation, a robust pre-edit component. However, opportunities to provide payment card transactions to areas beyond the reach of the central location may be missed using the large scale processing platform. Moreover, developing a new platform may be cost and time prohibitive as well as labor intensive.

Accordingly, it would be desirable to provide a system and/or method for processing and clearing payment card transactions within the political boundaries of a single country, commonwealth, or economic cooperation authority that can be implemented efficiently and separately from the large scale processing platform at the central location.

### BRIEF DESCRIPTION OF THE INVENTION

In one embodiment, a computer-based method for clearing payment card transactions using a computer device coupled to a database includes receiving from one or more local clearing users, financial transaction data relating to purchases made at one or more merchants by a plurality of payment card cardholder, the local clearing users located within a single clearing region, checking the received financial transaction data for errors, and performing a batch clearing process within the single clearing region on financial transaction data received in a predetermined period from the local clearing users within the single clearing region.

In another embodiment, a computer system for clearing payment card transactions, the computer system comprising: a memory device, a processor communicatively coupled to the memory device, the computer system further comprising a web-enabled server component configured to receive from one or more local clearing users, financial transaction data relating to purchases made at one or more merchants by a plurality of payment card cardholders, the local clearing users located within a single clearing region, a pre-edit component configured to determine if the received financial transaction data includes errors, and a batch clearing component within the single clearing region on financial transaction data received in a predetermined period from the local clearing users within the single clearing region.

In yet another embodiment, one or more non-transitory computer-readable storage media has computer-executable instructions embodied thereon, wherein when executed by at least one processor, the computer-executable instructions cause the processor to receive from one or more local clearing users, financial transaction data relating to purchases made at one or more merchants by a plurality of payment card cardholders in a cloud environment restricted to the local clearing users located within the political boundaries of a single country, commonwealth, or economic cooperation authority, determine if the received financial transaction data includes errors, return the financial transaction data to the local clearing users if errors are found, prepare the received financial transaction data for submission to a batch clearing process using one or more web-enabled servers, and perform a batch clearing process within the single clearing region on financial transaction data received in a predetermined period from the local clearing users within the single clearing region.

### BRIEF DESCRIPTION OF THE DRAWINGS

FIGS. 1-6 show example embodiments of the methods and systems described herein.

FIG. 1 is a schematic diagram illustrating an example multi-party payment card industry system for enabling ordinary payment-by-card transactions in which merchants and card issuers do not necessarily have a one-to-one relationship.

FIG. 2 is a simplified block diagram of an example system including a plurality of computer devices in accordance with one example embodiment of the present invention.

FIG. 3 is an expanded block diagram of an example embodiment of a server architecture of the system including the plurality of computer devices in accordance with one example embodiment of the present invention.

FIG. 4 illustrates an example configuration of a client system shown in FIGS. 2 and 3.

FIG. 5 illustrates an example configuration of a server system shown in FIGS. 2 and 3.

FIG. 6 illustrates a data flow diagram for RPS 40 in accordance with an example embodiment of the present disclosure.

### DETAILED DESCRIPTION OF THE INVENTION

Embodiments of the methods and systems described herein relate to establishing and operating a payment card transaction processing and clearing operation that is separate from the large scale processing platform at the central processing location. A remote processing system (RPS) is configured to leverage existing components of the large scale processing platform using only a subset of the resources of the large scale processing platform and tailored to the locale where the remote processing system is operating. The RPS may be one of a plurality of RPSs that operate independently, semi-independently, or fully dependent on the large scale processing platform. Typically, each RPS configured to operate independently and to communicate with the large scale processing platform periodically based on a predetermined schedule, which may be temporally-based or event-triggered. The RPS includes a pre-processing component that includes a version of a pre-edit component of the large scale processing platform. The pre-processing component may be configured to check the incoming payment card transaction data for errors and for compliance with local rules, regulations, laws, and protocols. The pre-processing component may also check for data errors comprising for example, but, not limited to data that is inconsistent within a record, data that is inconsistent within different records, or data that is inconsistent with other data sources. If the payment card transaction data includes errors, the pre-processing component may return the messages including the errors back to the sender for correction and resubmittal.

A complementary clearing companion component receives the pre-processed messages from the pre-processing component and completes a clearing process on the messages. The messages are all from within the political boundaries of a single country, commonwealth, or economic cooperation authority using a cloud environment and are received and the results are transmitted through a cloud environment that is restricted to the same country, commonwealth, or economic cooperation authority. The clearing companion component may be a subset of the capabilities of a clearing companion used in the large scale processing platform at the central location.

The methods and systems described herein may be implemented using computer programming or engineering techniques including computer software, firmware, hardware or any combination or subset thereof, wherein the technical effect may include at least one of: (a) receiving from one or more local clearing users, financial transaction data relating to purchases made at one or more merchants by a plurality of payment card cardholder, the local clearing users located within a single clearing region, (b) checking the received financial transaction data for errors, and (3) performing a batch clearing process within the single clearing region on financial transaction data received in a predetermined period from the local clearing users within the single clearing region.

As used herein, the terms “transaction card,” “financial transaction card,” and “payment card” refer to any suitable transaction card, such as a credit card, a debit card, a prepaid card, a charge card, a membership card, a promotional card, a frequent flyer card, an identification card, a prepaid card, a gift card, and/or any other device that may hold payment account information, such as mobile phones, smartphones, personal digital assistants (PDAs), key fobs, and/or computers. Each type of transactions card can be used as a method of payment for performing a transaction.

In one embodiment, a computer program is provided, and the program is embodied on a computer readable medium. In an example embodiment, the system is executed on a single computer system, without requiring a connection to a sever computer. In a further example embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of AT&T located in New York, N.Y.). The application is flexible and designed to run in various different environments without compromising any major functionality. In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

The following detailed description illustrates embodiments of the invention by way of example and not by way of limitation. It is contemplated that the invention has general application to processing financial transaction data by a third party in industrial, commercial, and residential applications.

As used herein, an element or step recited in the singular and proceeded with the word “a” or “an” should be understood as not excluding plural elements or steps, unless such exclusion is explicitly recited. Furthermore, references to “example embodiment” or “one embodiment” of the present invention are not intended to be interpreted as excluding the existence of additional embodiments that also incorporate the recited features.

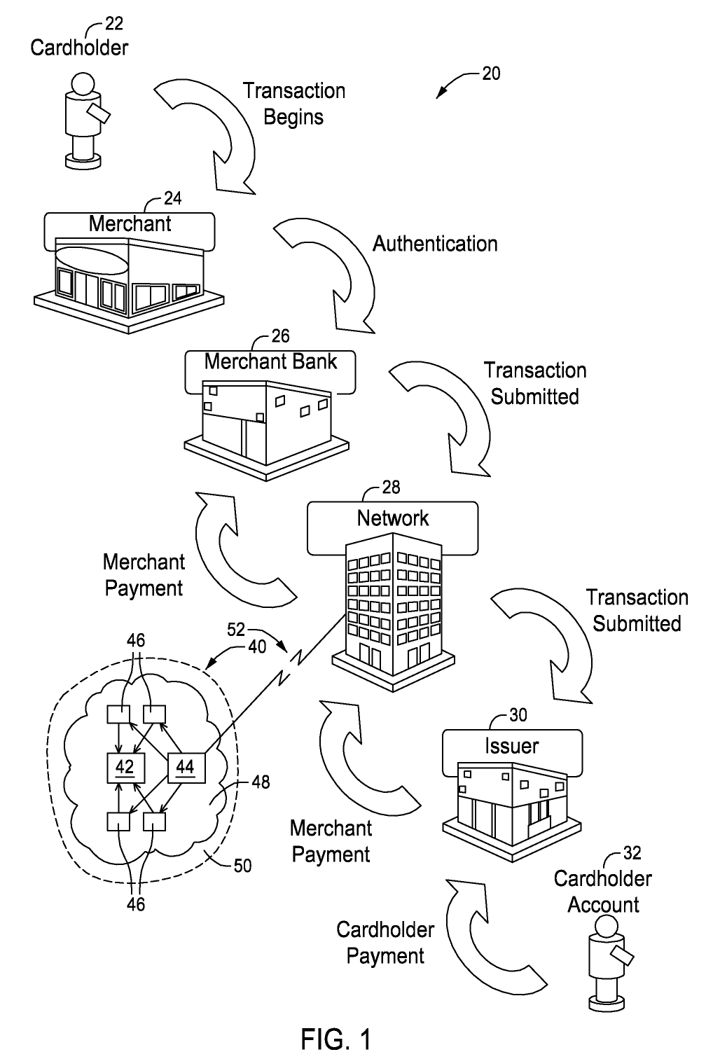

FIG. 1 is a schematic diagram illustrating an example multi-party transaction card industry system 20 for enabling ordinary payment-by-card transactions in which merchants 24 and card issuers 30 do not need to have a one-to-one special relationship. Embodiments described herein may relate to a transaction card system, such as a credit card payment system using the MasterCard® interchange network. The MasterCard® interchange network is a four-party payment card interchange network that includes a plurality of special purpose processors and data structures stored in one or more memory devices communicatively coupled to the processors, and a set of proprietary communications standards promulgated by MasterCard International Incorporated® for the exchange of financial transaction data and the settlement of funds between financial institutions that are members of MasterCard International Incorporated®. (MasterCard is a registered trademark of MasterCard International Incorporated located in Purchase, N.Y.).

In a typical transaction card system, a financial institution called the “issuer” issues a transaction card, such as a credit card, to a consumer or cardholder 22, who uses the transaction card to tender payment for a purchase from a merchant 24. To accept payment with the transaction card, merchant 24 must normally establish an account with a financial institution that is part of the financial payment system. This financial institution is usually called the “merchant bank,” the “acquiring bank,” or the “acquirer.” When cardholder 22 tenders payment for a purchase with a transaction card, merchant 24 requests authorization from a merchant bank 26 for the amount of the purchase. The request may be performed over the telephone, but is usually performed through the use of a point-of-sale terminal, which reads cardholder's 22 account information from a magnetic stripe, a chip, or embossed characters on the transaction card and communicates electronically with the transaction processing computers of merchant bank 26. Alternatively, merchant bank 26 may authorize a third party to perform transaction processing on its behalf. In this case, the point-of-sale terminal will be configured to communicate with the third party. Such a third party is usually called a “merchant processor,” an “acquiring processor,” or a “third party processor.”

Using an interchange network 28, computers of merchant bank 26 or merchant processor will communicate with computers of an issuer bank 30 to determine whether cardholder's 22 account 32 is in good standing and whether the purchase is covered by cardholder's 22 available credit line. Based on these determinations, the request for authorization will be declined or accepted. If the request is accepted, an authorization code is issued to merchant 24.

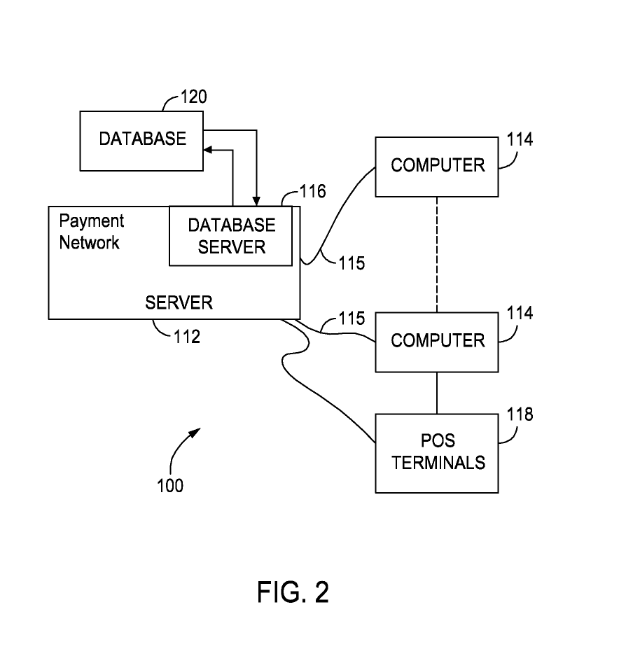

When a request for authorization is accepted, the available credit line of cardholder's 22 account 32 is decreased. Normally, a charge for a payment card transaction is not posted immediately to cardholder's 22 account 32 because bankcard associations, such as MasterCard International Incorporated®, have promulgated rules that do not allow merchant 24 to charge, or “capture,” a transaction until goods are shipped or services are delivered. However, with respect to at least some debit card transactions, a charge may be posted at the time of the transaction. When merchant 24 ships or delivers the goods or services, merchant 24 captures the transaction by, for example, appropriate data entry procedures on the point-of-sale terminal. This may include bundling of approved transactions daily for standard retail purchases. If cardholder 22 cancels a transaction before it is captured, a “void” is generated. If cardholder 22 returns goods after the transaction has been captured, a “credit” is generated. Interchange network 28 and/or issuer bank 30 stores the transaction card information, such as a type of merchant, amount of purchase, date of purchase, in a database 120 (shown in FIG. 2).

After a purchase has been made, a clearing process occurs to transfer additional transaction data related to the purchase among the parties to the transaction, such as merchant bank 26, interchange network 28, and issuer bank 30. More specifically, during and/or after the clearing process, additional data, such as a time of purchase, a merchant name, a type of merchant, purchase information, cardholder account information, a type of transaction, itinerary information, information regarding the purchased item and/or service, and/or other suitable information, is associated with a transaction and transmitted between parties to the transaction as transaction data, and may be stored by any of the parties to the transaction. In the example embodiment, when cardholder 22 purchases travel, such as airfare, a hotel stay, and/or a rental car, at least partial itinerary information is transmitted during the clearance process as transaction data. When interchange network 28 receives the itinerary information, interchange network 28 routes the itinerary information to database 120.

After a transaction is authorized and cleared, the transaction is settled among merchant 24, merchant bank 26, and issuer bank 30. Settlement refers to the transfer of financial data or funds among merchant's 24 account, merchant bank 26, and issuer bank 30 related to the transaction. Usually, transactions are captured and accumulated into a “batch,” which is settled as a group. More specifically, a transaction is typically settled between issuer bank 30 and interchange network 28, and then between interchange network 28 and merchant bank 26, and then between merchant bank 26 and merchant 24.

In various embodiments system 20 includes a remote processing system (RPS) 40 that may operate similarly to interchange network 28. In the example embodiment, RPS 40 includes a pre-processing component 42, a clearing companion component 44, and a plurality of clearing users 46 communicatively coupled in a cloud environment 48 and physically located within the political boundaries 50 of a single country, commonwealth, or economic cooperation authority.

At certain times, RPS 40 may communicate with system 20 through a communications link 52.

FIG. 2 is a simplified block diagram of an example processing system 100 including a plurality of computer devices in accordance with one embodiment of the present invention. System 100 may be representative of at least a portion of system 20 and/or RPS 40 and in certain respects may function similarly. In the example embodiment, system 100 may be used for performing payment-by-card transactions in a central location and in a main frame computer environment or system 100 may be used for performing payment-by-card transactions in a remote location and in a web-enabled server environment.

More specifically, in the example embodiment, system 100 includes a server system 112, and a plurality of client sub-systems, also referred to as client systems 114, connected to server system 112. In one embodiment, client systems 114 are computers including a web browser, such that server system 112 is accessible to client systems 114 using the Internet. Client systems 114 are interconnected to the Internet through many interfaces including a network, such as a local area network (LAN) or a wide area network (WAN), dial-in-connections, cable modems, and special high-speed Integrated Services Digital Network (ISDN) lines. Client systems 114 could be any device capable of interconnecting to the Internet including a web-based phone, PDA, or other web-based connectable equipment.

System 100 also includes point-of-sale (POS) terminals 118, which may be connected to client systems 114 and may be connected to server system 112. POS terminals 118 are interconnected to the Internet through many interfaces including a network, such as a local area network (LAN) or a wide area network (WAN), dial-in-connections, cable modems, wireless modems, and special high-speed ISDN lines. POS terminals 118 could be any device capable of interconnecting to the Internet and including an input device capable of reading information from a consumer's financial transaction card.

A database server 116 is connected to database 120, which contains information on a variety of matters, as described below in greater detail. In one embodiment, centralized database 120 is stored on server system 112 and can be accessed by potential users at one of client systems 114 by logging onto server system 112 through one of client systems 114. In an alternative embodiment, database 120 is stored remotely from server system 112 and may be non-centralized.

Database 120 may include a single database having separated sections or partitions or may include multiple databases, each being separate from each other. Database 120 may store transaction data generated as part of sales activities conducted over the processing network including data relating to merchants, account holders or customers, issuers, acquirers, purchases made. Database 120 may also store account data including at least one of a cardholder name, a cardholder address, an account number, and other account identifier. Database 120 may also store merchant data including a merchant identifier that identifies each merchant registered to use the network, and instructions for settling transactions including merchant bank account information. Database 120 may also store purchase data associated with items being purchased by a cardholder from a merchant, and authorization request data. Database 120 may store local rules, regulations, laws, and protocols for processing payment card transaction data in a local area web-enabled environment remote and separate from a centrally located main frame computer system according to the method described in the present disclosure.

In the example embodiment, one of client systems 114 may be associated with acquirer bank 26 (shown in FIG. 1) while another one of client systems 114 may be associated with issuer bank 30 (shown in FIG. 1). POS terminal 118 may be associated with a participating merchant 24 (shown in FIG. 1) or may be a computer system and/or mobile system used by a cardholder making an on-line purchase or payment. Server system 112 may be associated with interchange network 28. In the example embodiment, server system 112 is associated with a network interchange, such as interchange network 28, and may be referred to as an interchange computer system. Server system 112 may be used for processing transaction data. In addition, client systems 114 and/or POS 118 may include a computer system associated with at least one of an online bank, a bill payment outsourcer, an acquirer bank, an acquirer processor, an issuer bank associated with a transaction card, an issuer processor, a remote payment system, and/or a biller. Accordingly, each party involved in processing transaction data are associated with a computer system shown in system 100 such that the parties can communicate with one another as described herein.

Using the interchange network, the computers of the merchant bank or the merchant processor will communicate with the computers of the issuer bank to determine whether the consumer's account is in good standing and whether the purchase is covered by the consumer's available credit line. Based on these determinations, the request for authorization will be declined or accepted. If the request is accepted, an authorization code is issued to the merchant.

When a request for authorization is accepted, the available credit line of consumer's account is decreased. Normally, a charge is not posted immediately to a consumer's account because bankcard associations, such as MasterCard International Incorporated®, have promulgated rules that do not allow a merchant to charge, or “capture,” a transaction until goods are shipped or services are delivered. When a merchant ships or delivers the goods or services, the merchant captures the transaction by, for example, appropriate data entry procedures on the point-of-sale terminal. If a consumer cancels a transaction before it is captured, a “void” is generated. If a consumer returns goods after the transaction has been captured, a “credit” is generated.

For debit card transactions, when a request for a PIN authorization is approved by the issuer, the consumer's account is decreased. Normally, a charge is posted immediately to a consumer's account. The bankcard association then transmits the approval to the acquiring processor for distribution of goods/services, or information or cash in the case of an ATM.

After a transaction is captured, the transaction is settled between the merchant, the merchant bank, and the issuer. Settlement refers to the transfer of financial data or funds between the merchant's account, the merchant bank, and the issuer related to the transaction. Usually, transactions are captured and accumulated into a “batch,” which is settled as a group.

The financial transaction cards or payment cards discussed herein may include credit cards, debit cards, a charge card, a membership card, a promotional card, prepaid cards, and gift cards. These cards can all be used as a method of payment for performing a transaction. As described herein, the term “financial transaction card” or “payment card” includes cards such as credit cards, debit cards, and prepaid cards, but also includes any other devices that may hold payment account information, such as mobile phones, personal digital assistants (PDAs), key fobs, or other devices, etc.

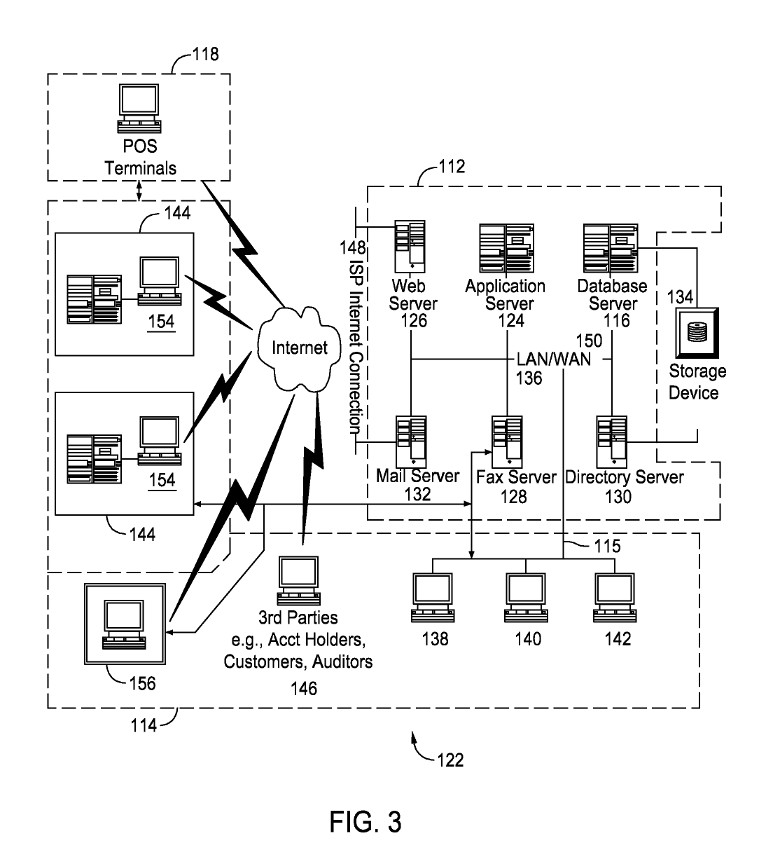

FIG. 3 is an expanded block diagram of an example embodiment of a server architecture of a processing system 122 including other computer devices in accordance with one embodiment of the present invention. Components in system 122, identical to components of system 100 (shown in FIG. 2), are identified in FIG. 3 using the same reference numerals as used in FIG. 2. System 122 includes server system 112, client systems 114, and POS terminals 118. Server system 112 further includes database server 116, a transaction server 124, a web server 126, a fax server 128, a directory server 130, and a mail server 132. A storage device 134 is coupled to database server 116 and directory server 130. Servers 116, 124, 126, 128, 130, and 132 are coupled in a local area network (LAN) 136.

Each workstation, 138, 140, and 142 is a personal computer having a web browser. Although the functions performed at the workstations typically are illustrated as being performed at respective workstations 138, 140, and 142, such functions can be performed at one of many personal computers coupled to LAN 136.

Server system 112 is configured to be communicatively coupled to various individuals, including employees 144 and to third parties, e.g., account holders, customers, auditors, developers, consumers, merchants, acquirers, issuers, etc., 146 using an ISP Internet connection 148. The communication in the example embodiment is illustrated as being performed using the Internet, however, any other wide area network (WAN) type communication can be utilized in other embodiments, i.e., the systems and processes are not limited to being practiced using the Internet. In addition, and rather than WAN 150, local area network 136 could be used in place of WAN 150.

In the example embodiment, any authorized individual having a workstation 154 can access system 122. At least one of the client systems includes a manager workstation 156 located at a remote location. Workstations 154 and 156 are personal computers having a web browser. Also, workstations 154 and 156 are configured to communicate with server system 112. Furthermore, fax server 128 communicates with remotely located client systems, including a client system 156 using a telephone link. Fax server 128 is configured to communicate with other client systems 138, 140, and 142 as well.

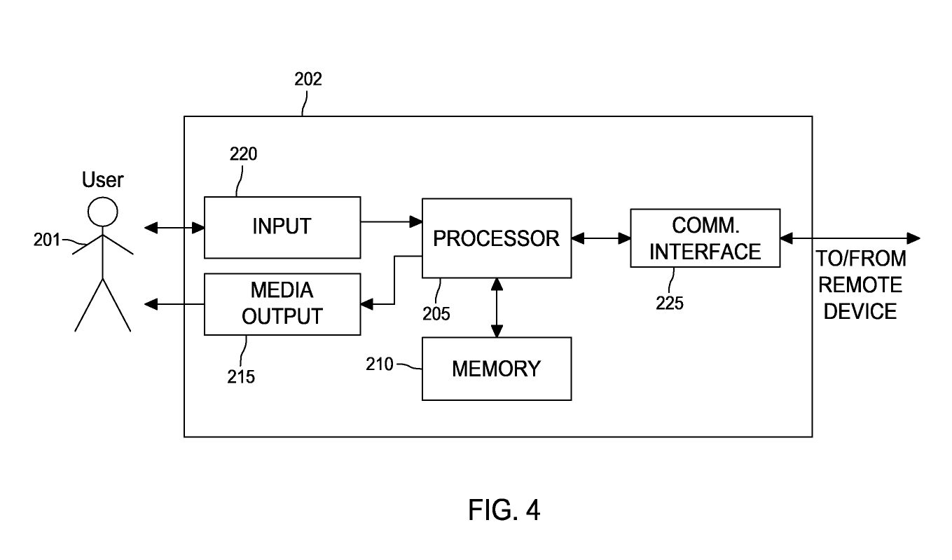

FIG. 4 illustrates an example configuration of a user system 202 operated by a user 201, such as cardholder 22 (shown in FIG. 1). User system 202 may include, but is not limited to, client systems 114, 138, 140, and 142, POS terminal 118, workstation 154, and manager workstation 156. In the example embodiment, user system 202 includes a processor 205 for executing instructions. In some embodiments, executable instructions are stored in a memory area 210. Processor 205 may include one or more processing units, for example, a multi-core configuration. Memory area 210 is any device allowing information such as executable instructions and/or written works to be stored and retrieved. Memory area 210 may include one or more computer readable media.

User system 202 also includes at least one media output component 215 for presenting information to user 201. Media output component 215 is any component capable of conveying information to user 201. In some embodiments, media output component 215 includes an output adapter such as a video adapter and/or an audio adapter. An output adapter is operatively coupled to processor 205 and operatively couplable to an output device such as a display device, a liquid crystal display (LCD), organic light emitting diode (OLED) display, or “electronic ink” display, or an audio output device, a speaker or headphones.

In some embodiments, user system 202 includes an input device 220 for receiving input from user 201. Input device 220 may include, for example, a keyboard, a pointing device, a mouse, a stylus, a touch sensitive panel, a touch pad, a touch screen, a gyroscope, an accelerometer, a position detector, or an audio input device. A single component such as a touch screen may function as both an output device of media output component 215 and input device 220. User system 202 may also include a communication interface 225, which is communicatively couplable to a remote device such as server system 112. Communication interface 225 may include, for example, a wired or wireless network adapter or a wireless data transceiver for use with a mobile phone network, Global System for Mobile communications (GSM), 3G, or other mobile data network or Worldwide Interoperability for Microwave Access (WIMAX).

Stored in memory area 210 are, for example, computer readable instructions for providing a user interface to user 201 via media output component 215 and, optionally, receiving and processing input from input device 220. A user interface may include, among other possibilities, a web browser and client application. Web browsers enable users, such as user 201, to display and interact with media and other information typically embedded on a web page or a website from server system 112. A client application allows user 201 to interact with a server application from server system 112.

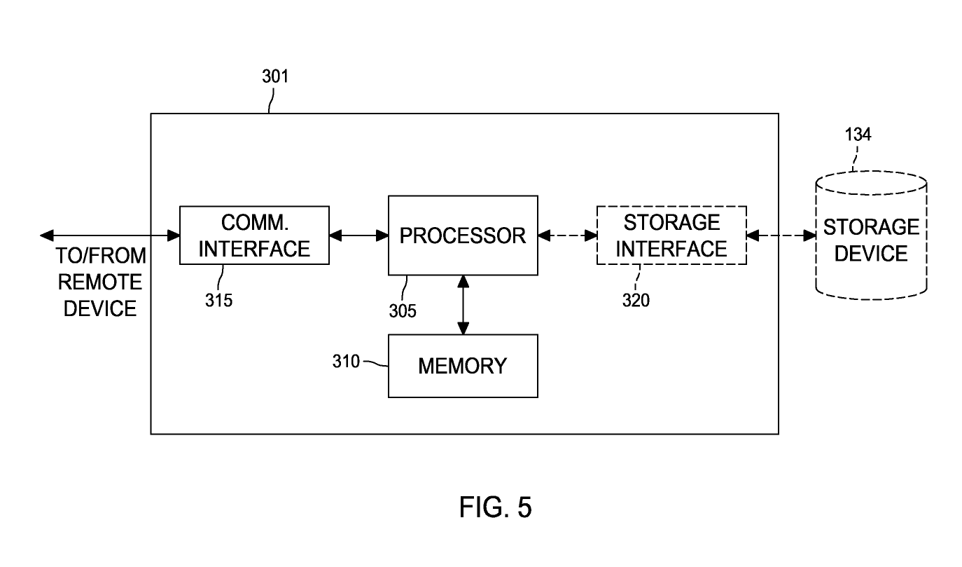

FIG. 5 illustrates an example configuration of a server system 301 such as server system 112 (shown in FIGS. 2 and 3). Server system 301 may include, but is not limited to, database server 116, transaction server 124, web server 126, fax server 128, directory server 130, and mail server 132.

Server system 301 includes a processor 305 for executing instructions. Instructions may be stored in a memory area 310, for example. Processor 305 may include one or more processing units (e.g., in a multi-core configuration) for executing instructions. The instructions may be executed within a variety of different operating systems on the server system 301, such as UNIX, LINUX, Microsoft Windows®, etc. It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages, etc).

Processor 305 is operatively coupled to a communication interface 315 such that server system 301 is capable of communicating with a remote device such as a user system or another server system 301. For example, communication interface 315 may receive requests from user system 114 via the Internet, as illustrated in FIGS. 2 and 3.

Processor 305 may also be operatively coupled to a storage device 134. Storage device 134 is any computer-operated hardware suitable for storing and/or retrieving data. In some embodiments, storage device 134 is integrated in server system 301. For example, server system 301 may include one or more hard disk drives as storage device 134. In other embodiments, storage device 134 is external to server system 301 and may be accessed by a plurality of server systems 301. For example, storage device 134 may include multiple storage units such as hard disks or solid state disks in a redundant array of inexpensive disks (RAID) configuration. Storage device 134 may include a storage area network (SAN) and/or a network attached storage (NAS) system.

In some embodiments, processor 305 is operatively coupled to storage device 134 via a storage interface 320. Storage interface 320 is any component capable of providing processor 305 with access to storage device 134. Storage interface 320 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 305 with access to storage device 134.

Memory area 310 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are examples only, and are thus not limiting as to the types of memory usable for storage of a computer program.

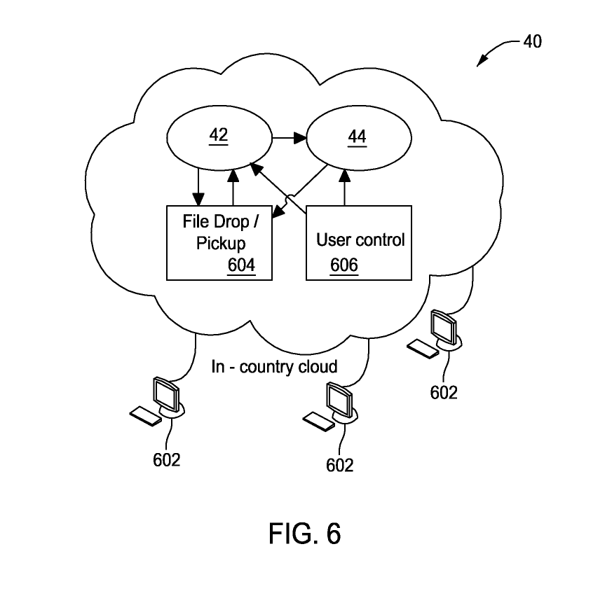

FIG. 6 illustrates a data flow diagram for RPS 40 in accordance with an example embodiment of the present disclosure. In the example embodiment, a plurality of clearing users 602 are communicatively coupled to RPS 40 through in-country cloud 48. Users 602 are typically banks or financial institutions involved in a multi-party payment card transaction interchange.

Each of users 602 is able to upload payment card transaction data to a file-drop/file-pickup component 604 and to upload processing commands and preferences to a user control component 606. Payment card transaction data received at file-drop/file-pickup component 604 is forwarded to pre-processing component 42 and acted upon using the commands and preferences uploaded to user control component 606. Pre-processing component 42 checks the payment card transaction data for errors and if errors are discovered, pre-processing component 42 may return the payment card transaction data to the respective user 602 for correction and resubmittal. If the received payment card transaction data is error-free or if the errors have been removed, the payment card transaction data is transmitted to clearing companion component 44 where a clearing process is performed. The results of the clearing process and any reports generated are transmitted to file-drop/file-pickup component 604 for retrieval by the respective user that submitted the payment card transaction data.

The term processor, as used herein, refers to central processing units, microprocessors, microcontrollers, reduced instruction set circuits (RISC), application specific integrated circuits (ASIC), logic circuits, and any other circuit or processor capable of executing the functions described herein.

As used herein, the terms “software” and “firmware” are interchangeable, and include any computer program stored in memory for execution by processor 205 or 305, including RAM memory, ROM memory, EPROM memory, EEPROM memory, and non-volatile RAM (NVRAM) memory. The above memory types are examples only, and are thus not limiting as to the types of memory usable for storage of a computer program.

As will be appreciated based on the foregoing specification, the above-discussed embodiments of the invention may be implemented using computer programming or engineering techniques including computer software, firmware, hardware or any combination or subset thereof. Any such resulting program, having computer-readable and/or computer-executable instructions, may be embodied or provided within one or more computer-readable media, thereby making a computer program product, i.e., an article of manufacture, according to the discussed embodiments of the invention. The computer readable media may be, for instance, a fixed (hard) drive, diskette, optical disk, magnetic tape, semiconductor memory such as read-only memory (ROM) or flash memory, etc., or any transmitting/receiving medium such as the Internet or other communication network or link. The article of manufacture containing the computer code may be made and/or used by executing the instructions directly from one medium, by copying the code from one medium to another medium, or by transmitting the code over a network.

The above-described embodiments of a method and system of processing payment card transaction data provides a cost-effective and reliable means improving processing of payment card transaction data in a remote market such as, but, not limited to a country, a commonwealth, or an economic cooperation authority. More specifically, the methods and systems described herein facilitate leveraging existing mainframe environment applications for web-based remote application, which are server-based applications. As a result, the methods and systems described herein facilitate expanding financial services to locations remote from a central location mainframe computer system in a cost-effective and reliable manner.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A computer-based method for clearing payment card transactions, the method implemented using a computer device coupled to a memory device, the method comprising:
receiving from one or more local clearing users, financial transaction data relating to purchases made at one or more merchants by a plurality of payment card cardholder, the local clearing users located within a single clearing region;
checking the received financial transaction data for errors; and
performing a batch clearing process within the single clearing region on financial transaction data received in a predetermined period from the local clearing users within the single clearing region.

2. The computer-based method of claim 1, wherein performing a batch clearing process within the single clearing region comprises performing a batch clearing process within the single clearing region that comprises political boundaries of a country, commonwealth, or economic cooperation authority.

3. The computer-based method of claim 1, wherein checking the received financial transaction data for errors comprises returning the financial transaction data to the local clearing users if errors are found.

4. The computer-based method of claim 1, wherein checking the received financial transaction data for errors comprises checking the received financial transaction data for errors that include data inconsistent with other data within each record of the financial transaction data, wherein each record relates to a single purchase.

5. The computer-based method of claim 1, wherein checking the received financial transaction data for errors comprises checking the received financial transaction data for errors that include data inconsistent within a record with respect to data in other records.

6. The computer-based method of claim 1, wherein checking the received financial transaction data for errors comprises checking the received financial transaction data for errors that include data inconsistent with data within a record with respect to data in other data sources.

7. The computer-based method of claim 1, wherein receiving from one or more local clearing users comprises receiving from one or more local clearing users, financial transaction data relating to purchases made at one or more merchants by a plurality of payment card cardholder in a cloud environment restricted to the single clearing region.

8. The computer-based method of claim 1, wherein preparing the received financial transaction data for submission to a batch clearing process comprises preparing the received financial transaction data for submission to a batch clearing process using one or more web-enabled servers.

9. A computer system for clearing payment card transactions, the computer system comprising:
a memory device;
a processor communicatively coupled to the memory device, the computer system further comprising:
a web-enabled server component configured to receive from one or more local clearing users, financial transaction data relating to purchases made at one or more merchants by a plurality of payment card cardholders, the local clearing users located within a single clearing region;
a pre-edit component configured to determine if the received financial transaction data includes errors; and
a batch clearing component within the single clearing region on financial transaction data received in a predetermined period from the local clearing users within the single clearing region.

10. The computer system of claim 9, wherein the batch clearing component is configured to perform a batch clearing within the political boundaries of a country, commonwealth, or economic cooperation authority on financial transaction data received from within that same country, commonwealth, or economic cooperation authority.

11. The computer system of claim 9, wherein the pre-edit component is configured to determine if the received financial transaction data includes errors.

12. The computer system of claim 9, wherein the pre-edit component is configured to return the financial transaction data to the local clearing users if errors are found in the received financial transaction data.

13. The computer system of claim 9, wherein the pre-edit component is configured to determine if the received financial transaction data includes errors that include data inconsistent with other data within each record of the financial transaction data, wherein each record relates to a single purchase.

14. The computer system of claim 9, wherein the pre-edit component is configured to determine if the received financial transaction data includes errors that include data inconsistent within a record with respect to data in other records.

15. The computer system of claim 9, wherein the web-enabled server component is configured to receive from one or more local clearing users, financial transaction data relating to purchases made at one or more merchants by a plurality of payment card cardholder in a cloud environment restricted to the single clearing region.

16. The computer system of claim 9, wherein the web-enabled server component is configured to prepare the received financial transaction data for submission to a batch clearing component using one or more web-enabled servers.

17. One or more non-transitory computer-readable storage media having computer-executable instructions embodied thereon, wherein when executed by at least one processor, the computer-executable instructions cause the processor to:
receive from one or more local clearing users, financial transaction data relating to purchases made at one or more merchants by a plurality of payment card cardholders in a cloud environment restricted to the local clearing users located within the political boundaries of a single country, commonwealth, or economic cooperation authority;
determine if the received financial transaction data includes errors
return the financial transaction data to the local clearing users if errors are found;
prepare the received financial transaction data for submission to a batch clearing process using one or more web-enabled servers; and
perform a batch clearing process within the single clearing region on financial transaction data received in a predetermined period from the local clearing users within the single clearing region.

18. The computer-readable storage media of claim 17, wherein the computer-executable instructions further cause the processor to check the received financial transaction data for errors that include data inconsistent with other data within each record of the financial transaction data, wherein each record relates to a single purchase.

19. The computer-readable storage media of claim 17, wherein the computer-executable instructions further cause the processor to check the received financial transaction data for errors that include data inconsistent within a record with respect to data in other records.

20. The computer-readable storage media of claim 17, wherein the computer-executable instructions further cause the processor to check the received financial transaction data for errors that include data inconsistent with data within a record with respect to data in other data sources.
